(19) United States
(12) Patent Application Publication
(10) Pub. No.: US 2025/0303689 A1
(43) Pub. Date: Oct. 2, 2025

(54) METHODS AND SYSTEMS FOR DELAMINATING PHOTOVOLATIC PANELS

(71) Applicant: University of Kansas, Lawrence, KS (US)

(72) Inventors: Bala Subramaniam, Lawrence, KS (US); Hongda Zhu, Lawrence, KS (US); Daniel J. Hastert, Lawrence, KS (US)

(21) Appl. No.: 19/082,849

(22) Filed: Mar. 18, 2025

Related U.S. Application Data
(60) Provisional application No. 63/572,788, filed on Apr. 1, 2024.
(60) Provisional application No. 63/669,825, filed on Jul. 11, 2024.

(51) Int. Cl. B32B 43/00

(52) U.S. Cl. CPC B32B 43/006; B32B 2457/12

(57) ABSTRACT

A method for delaminating a multilayer structure is provided, the method comprising exposing a multilayer structure in contact with a liquid medium to sound waves characterized by a first frequency and sound waves characterized by a second, different frequency, the multilayer structure comprising a solid front layer, a solid back layer, and a polymer interlayer comprising a polymer in between the solid front layer and the solid back layer, wherein the exposure separates the solid front layer, the solid back layer, the polymer interlayer, or combinations thereof from the multilayer structure. Systems for carrying out the methods are also provided.

### CROSS-REFERENCE TO RELATED APPLICATIONS

The present application claims priority to U.S. Provisional Patent Application No. 63/572,788 that was filed Apr. 1, 2024, the entire contents of which are hereby incorporated by reference and to U.S. Provisional Patent Application No. 63/669,825 that was filed Jul. 11, 2024, the entire contents of which are hereby incorporated by reference

### REFERENCE TO GOVERNMENT RIGHTS

This invention was made with government support under EE0010496 awarded by the Department of Energy. The government has certain rights in the invention.

### BACKGROUND

To reduce carbon emissions, a considerable increase in solar power capacity is needed. By 2050, demand for solar power is estimated to be as much as 100 Terawatts. Critical materials such as cadmium (Cd) and tellurium (Te) are essential to produce high efficiency cadmium telluride photovoltaic (PV) panels. Tellurium (Te) is as rare as platinum and its primary production is limited by copper ore refining. To economically produce these high efficiency thin film solar cells, a robust circular supply chain must be developed. This requires cost effective and environmentally benign technologies to recover and recycle the critical minerals. Disposing off end-of-life solar panels in landfills will not only rapidly deplete the critical energy metals but also disperse environmentally regulated metals including cadmium (Cd). However, deconstructing and recycling intact solar panels is challenging due, in part, to recalcitrant polymeric materials used in the production of long-life solar panels. These polymeric materials are used as sealants to exclude oxygen, moisture and dust that degrade the semiconductor materials and/or as the adhesives used to adhere various layers of the solar panels together.

### SUMMARY

Methods and systems for delaminating multilayer structures, e.g., photovoltaic (PV) panels, are provided. The methods and systems comprise exposing the multilayer structure to sound waves that induce two different vibrational modes within the multilayer structure. Without wishing to be bound to a particular theory, it is believed that these two vibrational modes act synergistically to achieve efficient and effective delamination of the layers of the multilayer structure.

In one aspect, a method for delaminating a multilayer structure is provided, the method comprising exposing a multilayer structure in contact with a liquid medium to sound waves characterized by a first frequency and sound waves characterized by a second, different frequency, the multilayer structure comprising a solid front layer, a solid back layer, and a polymer interlayer comprising a polymer in between the solid front layer and the solid back layer, wherein the exposure separates the solid front layer, the solid back layer, the polymer interlayer, or combinations thereof from the multilayer structure.

In another aspect, a system for delaminating a multilayer structure is provided, the system comprising: a delamination vessel defining an interior chamber configured to contain a liquid medium and a multilayer structure in contact with the liquid medium; a source mounted to the delamination vessel and configured to generate sound waves that impact the multilayer structure; and a controller comprising a processor, and a non-transitory computer-readable medium operably coupled to the processor, the non-transitory computer-readable medium comprising instructions that, when executed by the processor perform operations comprising: exposing a multilayer structure mounted in the delamination vessel and in contact with a liquid medium therein to sound waves characterized by a first frequency and sound waves characterized by a second, different frequency, the multilayer structure comprising a solid front layer, a solid back layer, and a polymer interlayer comprising a polymer in between the solid front layer and the solid back layer, wherein the exposure separates the solid front layer, the solid back layer, the polymer interlayer, or combinations thereof from the multilayer structure.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIG. 1 shows a schematic of a cross-section of an illustrative photovoltaic (PV) panel that may be delaminated using the present systems and methods.

FIG. 2 shows another illustrative multilayer structure that may be delaminated using the present systems and methods. Although not shown in this figure, other material layers, e.g., semiconductor layers, conductive layers, etc., may be positioned between the front layer and the polymer interlayer.

FIGS. 3A and 3B show, schematically, an illustrative delamination system 300 that may be used to carry out the present methods.

FIGS. 4A and 4B show cross-sectional views of an illustrative delamination vessel 308 of the delamination system 300. In FIG. 4B, the delamination vessel 308 is shown mounted on an exciter 306, providing a source of propagating sound waves.

FIG. 5A shows a cross-section view of a portion of another illustrative delamination vessel configured to contain a liquid medium and multiple samples (versus a single sample). FIG. 5B shows a perspective view of a similarly configured delamination vessel for multiple samples.

FIGS. 6A and 6B are plots showing the trigger signal (equivalent to the input waveform sent to the amplifier 304 for driving the exciter 306 in the delamination system 300) and the resulting response signal from a piezoelectric chip in contact with the sample. FIG. 6A is a plot of the response signal at a sound wave frequency of 183.4 Hz and FIG. 6B at a sound wave frequency of 237.8 Hz.

FIG. 7A shows a normalized plot of a chirp waveform used to perform a frequency sweep protocol (this may also be referred to as a frequency response evaluation protocol) in the delamination system 300. FIG. 7B is a magnitude plot obtained by the complex Fast Fourier Transform (FFT) of the chirp waveform of FIG. 7A.

FIG. 8A shows a plot of a measured response signal induced by a 129.7 Hz chirp waveform as the input waveform. FIG. 8B is a magnitude plot of the complex FFT of the measured response signal of FIG. 8A.

FIG. 9 is a schematic illustration showing that glass bending vibration modes, induced by transverse sound waves, correspond to low resonance frequencies and aid in polyolefin removal from sample edges. Polymer interlayer compression vibration modes, induced by longitudinal sound waves, appear to correspond to high resonance frequencies.

FIG. 10 provides a visual illustration of the various vibration modes and their resonance frequencies of a sample having lateral dimensions of 24.6 mm and a polymer interlayer having the same lateral dimensions (left image). The intensity plots show a top view of the vibration modes and the resonance frequencies of these modes are qualitatively mapped onto the adjacent frequency scale. FIG. 10 further shows that the resonance frequencies of these vibration modes can change and new vibration modes appear as the lateral dimensions of the polymer interlayer change (right image).

FIG. 11 shows vibration modes of a layer of a sample as shown with vibration nodes labeled with the filled circles.

FIG. 12 depicts illustrative operations which may be performed by an application of the controller of FIG. 3B to generate frequency domain data according to a frequency sweep protocol.

FIG. 13 depicts illustrative operations which may be performed by an application of the controller of FIG. 3B to process the frequency domain data.

FIG. 14 depicts illustrative operations which may be performed by an application of the controller of FIG. 3B to control components of the delamination system of FIG. 3B based on the generated and/or processed frequency domain data.

### DETAILED DESCRIPTION

Provided are methods for delaminating multilayer structures. In an embodiment, such a method comprises exposing a multilayer structure in contact with a liquid medium to sound waves characterized by a first frequency and sound waves characterized by a second, different frequency. The exposure step induces delamination of the multilayer structure, i.e., separation of two or more layers of the multilayer structure from one another. The multilayer structure comprises a front layer, a back layer, and a polymer interlayer between the front and back layer. The polymer interlayer is adhered to the front layer, the back layer, or both, either directly (i.e., forming an interface with each) or indirectly (via other layers constituting the multilayer structure). Although the present methods may be used to separate layers of a variety of multilayer structures, they may be illustrated by reference to a specific multilayer structure and components thereof, a photovoltaic (PV) panel.

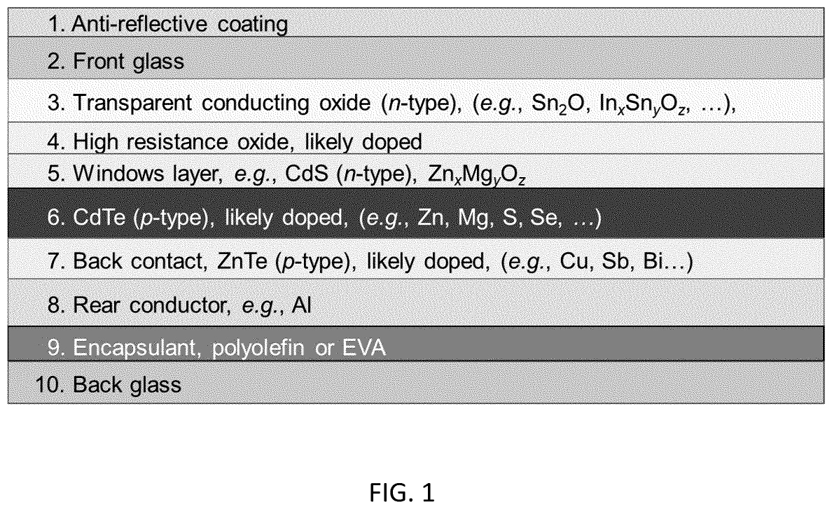

Regarding a PV panel, this refers to a multilayer structure configured to generate electricity from light, e.g., sunlight. A schematic of a cross-section of an illustrative PV panel is shown in FIG. 1. The individual layers of the multilayer structure are labeled and include a front glass layer and a back glass layer between which multiple other material layers are sandwiched. The front glass layer and the back glass layer may be composed of various glasses which may be referred to as solar glass or PV glass. Illustrative such types of glasses include tempered glass, float glass, low-iron glass, borosilicate glass, soda-lime glass, lead crystal glass, etc., Among these other material layers is a polymer interlayer comprising a polymer, the type of which depends upon the PV panel being used, including the composition of the other material layers therein. Illustrative polymers include ethylene-vinyl acetate copolymers, polyolefins, polyesters, and polyester-modified ethylene-vinyl acetate copolymers. The ethylene vinyl acetate copolymers may be those comprising ethylene-hexene or ethylene-octylene. Polymers such as PET (polyethylene terephthalate), PEN (polyethylene napthalate) may be used (e.g., as encapsulants), and fluoropolymers such as PVF (polyvinyl fluoride) may be used (e.g., as back sheets). As shown in FIG. 1, the polymer interlayer may be adhered to the back glass layer on one surface and to a rear conductor layer on an opposing surface. As also shown in FIG. 1, the PV panel may be a CdTe PV panel comprising absorber layer comprising CdTe. However, the present methods are not limited to any particular type of PV panel (i.e. not limited to either thin-film- or wafer-based PV technology, to any particular type of polymer, or to a single layer of polymer). Other PV panels having different material layers and/or other configurations as compared to that shown in FIG. 1 may be used. As further described below, an appropriate combination of liquid medium and sound wave frequencies may be selected (along with other conditions) to delaminate a wide variety of PV panels.

Delamination of a PV panel using the present methods, including that shown in FIG. 1, includes separating specific layers of the PV panel from one another, e.g., separating the polymer interlayer from an adjacent layer, e.g., the back glass layer and/or the rear conductor layer.

The PV panel to be delaminated by the present methods may be intact, by which it is meant the PV panel has a morphology similar to the morphology of the PV panel during use to generate electricity. This is by contrast to PV panels that have been subjected to a mechanical force sufficient to crack one or multiple layer(s) of the PV panel or to break apart or crush the PV panel into particles. However, “intact” also encompasses a PV panel that has been deliberately divided into pieces which are referred to herein as “swarfs.” Such swarfs are distinguished from randomly crushed particles of a PV panel by size. The swarfs are substantially larger in size and may have lateral dimensions (e.g., length, width), at least 2 mm, at least 5 mm, at least 10 mm, at least 25 mm, at least 50 mm, at least 1 cm, at least 3 cm, or at least 6 cm. This includes a range of sizes between any of these values.

As noted above, in the present methods the PV panel is in contact with a liquid medium. The sound waves generally propagate through this liquid medium and impact the PV panel to induce delamination thereof, but sound waves may also propagate through other materials in contact with the PV panel (e.g., components of a delamination vessel in which the present methods are carried out). The PV panel may be immersed in the liquid medium such that it is surrounded on all its surfaces by the liquid medium. However, in embodiments, partial immersion is sufficient, provided at least the polymer interlayer is immersed in the liquid medium. In such embodiments, some layers of the PV panel need not be immersed or contacted by the liquid medium. The liquid medium and the PV panel therein may be contained within an interior chamber of a delamination vessel of a system configured to carry out the present methods. (Such a system will be further described below.) As the composition of the liquid medium affects the characteristics of the sound waves propagating therethrough, the composition may be selected to facilitate delamination. The composition of the liquid medium is also guided by the type of polymer interlayer. Compositions having chemical similarity with and ability to at least partially solubilize the polymer of the polymer interlayer under the conditions being used (e.g., delamination temperature) are desirable. Illustrative materials that may be used to provide the liquid medium include aliphatic hydrocarbons, including linear and branched alkanes having from 4 to 12 carbon atoms, e.g., n-butane, n-pentane, n-hexane, n-heptane, iso-octane, etc. A single type or a combination of different types of materials may be used in the liquid medium. Regarding combinations, in embodiments, a combination of any of the disclosed aliphatic hydrocarbons and dissolved carbon dioxide may be used. In embodiments, a combination of a light alkane (e.g., C3 and/or C4) and a heavier alkane (e.g., C5 or greater) may be used. In embodiments, however, some liquid media may be excluded from use such as carbon dioxide and aromatic hydrocarbons such as toluene.

The sound waves being used in the present methods are provided by a source, e.g., a transducer configured to generate acoustic waves from an electrical signal. Terms such as transducer, speaker, exciter, driver may be used interchangeably in reference to the sound wave source. The transducer may be electrostatic, electromagnetic, piezoelectric, etc. In embodiments, some transducers may be excluded from use, such as an ultrasound transducer configured to generate ultrasound waves. Because the present methods comprise the use of sound waves having at least two different frequencies and individual sources may have a limited power rating, multiple sources may be used, each configured to generate acoustic waves of the appropriate frequency. The two different frequencies may be generated simultaneously. Without wishing to be bound to a particular theory, it is believed that simultaneous generation of the two different frequencies enables them to act synergistically to more efficiently and effectively delaminate the PV panels than if the two different frequencies were generated separately. However, in other embodiments, the two different frequencies may be generated sequentially. More than two different frequencies may be used, e.g., three, four, etc.

The frequencies of the sound waves being used in the present methods, including the two different frequencies, correspond to certain resonance frequencies of the PV panel to be delaminated. One of the resonance frequencies is a low frequency (relative to the other frequency) that may correspond to a transverse sound wave that induces a bending vibration mode of one (or both) of the front glass layer and the back glass layer of the PV panel. The other of the resonance frequencies is a high frequency (relative to the low frequency) that may correspond to a longitudinal sound wave that induces a compression vibration mode of the polymer interlayer. Thus, the specific values of the low and high frequencies depend upon the characteristics of the PV panel, including the type of glass of the front and back layers, the type of polymer of the polymer interlayer, as well as the respective dimensions and shapes of these layers. The resonance frequencies of the PV panel to be delaminated may be determined using a frequency sweep protocol as further described below and demonstrated in the following Example. This frequency sweep protocol may also be used to determine an input waveform for driving the source of the sound waves that ensures that the sound waves that ultimately impact the PV panel include those of the desired frequencies.

Illustrative values of the first frequency (e.g., low frequency) sound waves that may be used include: 900 Hz or less, 500 Hz or less, 475 Hz or less, 450 Hz or less, 425 Hz or less, 400 Hz or less, 375 Hz or less, 350 Hz or less, 325 Hz or less, 300 Hz or less, 275 Hz or less, 250 Hz or less, 225 Hz or less, 200 Hz or less, 175 Hz or less, 150 Hz or less, 125 Hz or less, 100 Hz or less, 95 Hz or less, 90 Hz or less. A range of between any of these values may be used, e.g., from 85 Hz to 500 Hz. Illustrative values of the second frequency (e.g., high frequency) sound waves that may be used include: 1000 Hz or greater, 1025 Hz or greater, 1050 Hz or greater, 1075 Hz or greater, 1100 Hz or greater, 1125 Hz or greater, 1150 Hz or greater, 1175 Hz or greater, 1200 Hz or greater, 1225 Hz or greater, 1275 Hz or greater, 1300 Hz or greater, 1325 Hz or greater, 1350 Hz or greater, 1375 Hz or greater, 1400 Hz or greater, 1425 Hz or greater, 1450 Hz or greater, or 1475 Hz or greater. In embodiments, however, high frequencies up to 2 kHz, 3.5 kHz, or 6 kHz may be used. A range of between any of the high frequency values may be used, e.g., from 1000 Hz to 1500 Hz. Various combinations of the first and second frequencies may be used. Specific illustrative combinations are provided in the Example, below.

The first and second frequencies being used may also be characterized by a frequency ratio given as [second (or high) frequency]/[first (or low) frequency], wherein various first and second frequencies may be used provided the frequency ratio is a certain value. In embodiments, the frequency ratio is greater than 1, at least 2, at least 4, at least 6, at least 8, at least 10, or at least 12. This includes a range between any of these frequency ratios, e.g., from 2 to 15.

In embodiments, ultrasound frequencies are not used, including frequencies of 20 kHz or greater.

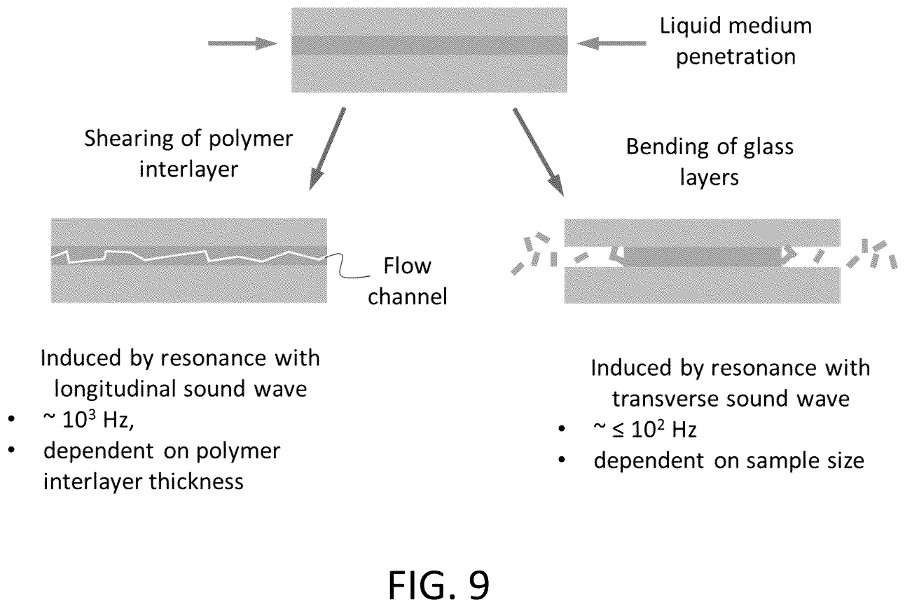

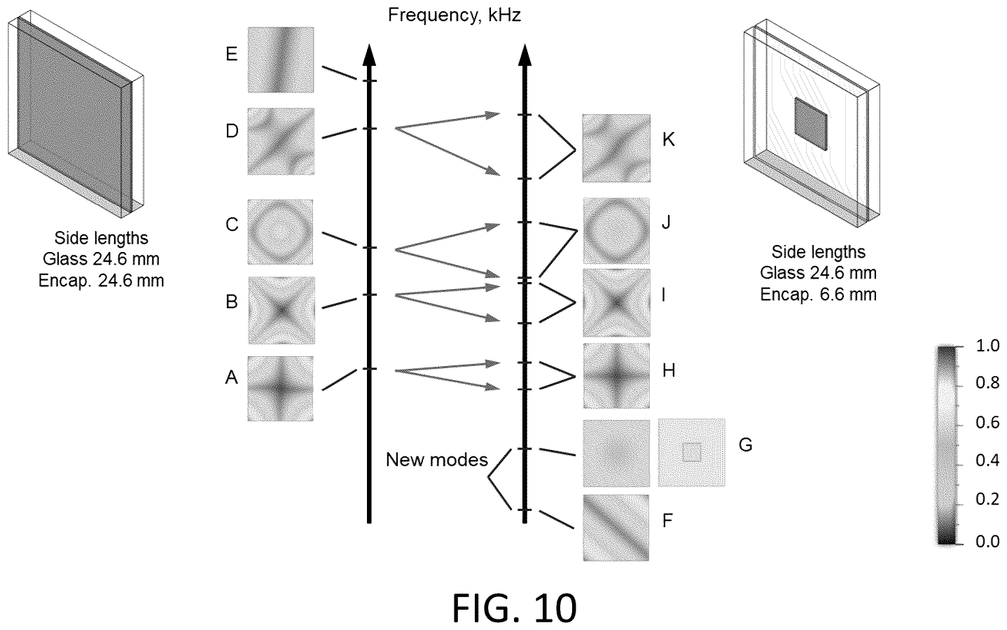

The low and high resonance frequencies (corresponding to certain vibrational modes) of a multilayer structure composed of a front glass layer, a back glass layer, and a polymer interlayer between are illustrated by reference to FIG. 9. The multiple resonance frequencies and associated vibrational modes of the multilayer structure are further illustrated by reference to FIG. 10. These figures are further described in detail in the Example, below.

In addition to sound wave frequency, the conditions under which the exposure occurs may further comprise parameters, e.g., sound wave profile, sound wave power delamination pressure, delamination temperature, and delamination time, each which may be adjusted to facilitate delamination. Regarding sound wave profile, this includes the shape of the input waveform(s) used to drive the source(s) of the sound waves, as well as the relative phase/time lag between sound waves at different frequencies. In embodiments, a profile of a sinusoidal waveform without a phase lag is used. Regarding sound wave power, this refers to the power being used to generate the sound waves, i.e., the power of the sound wave source (including via an amplifier). Illustrative powers that may be used include those in a range of from 1 W to 50 W, from 2 W to 25 W, and from 4 W to 15 W, and various combinations of the values in these ranges. Sound waves having different frequencies may also have different profiles and/or different powers.

Regarding delamination pressure and delamination temperature, this refers to the pressure and temperature within the interior chamber containing the liquid medium and the PV panel. In addition to facilitating delamination, the delamination pressure and delamination temperature may be selected to ensure that the liquid medium remains a liquid during delamination. Illustrative delamination pressures include those in the range of from sub-atmospheric pressure (about 0.3 bar) to 2.7 bar. Atmospheric pressure may be used. Illustrative delamination temperatures include those in the range of from room temperature (20 to 25° C.) to 65° C., from room temperature to 60° C., from room temperature to 55° C., from room temperature to 45° C., and various combinations of the values in these ranges.

Regarding delamination time, this refers to the period of time the PV panel is exposed to the sound waves in the liquid medium. Illustrative delamination times include from 10 minutes to 10 hours, from 10 minutes to 5 hours, from 10 minutes to 2 hours, and various combinations of the values in these ranges. Finally, the conditions may further include a certain number of cycles of exposing the PV panel to the sound waves in the liquid medium under a certain set of conditions. Again, the number of cycles, e.g., 2, 6, 10, etc., may be selected to facilitate delamination.

Prior to exposing the PV panel to the propagating sound waves, the present methods may include an annealing step comprising heating the PV panel in contact with the liquid medium for a period of time. The annealing step does not involve the use of sound waves. As demonstrated in the Example, below, this has been found to be useful to minimize the cracking and shattering of the front and/or back glass layers. The annealing temperature used during the heating may be greater than that used during exposure to the propagating sound waves. The annealing temperature may be, e.g., in a range of from 55° C. to 70° C., or from 60° C. to 75° C. The annealing time may be, e.g., in a range of from 15 min to 2 hours. Illustrative annealing temperatures and times are provided in the Example, below.

After exposing the PV panel to the propagating sound waves, e.g., if some amount of the polymer interlayer remains adhered to a delaminated material layer of the PV panel, the present methods may include a step of immersing the delaminated material layer in any of the disclosed liquid media. The temperature and time may be adjusted to ensure complete removal of the polymer interlayer. In this step, ultrasound vibrations may be applied to substantially reduce the time required for complete removal.

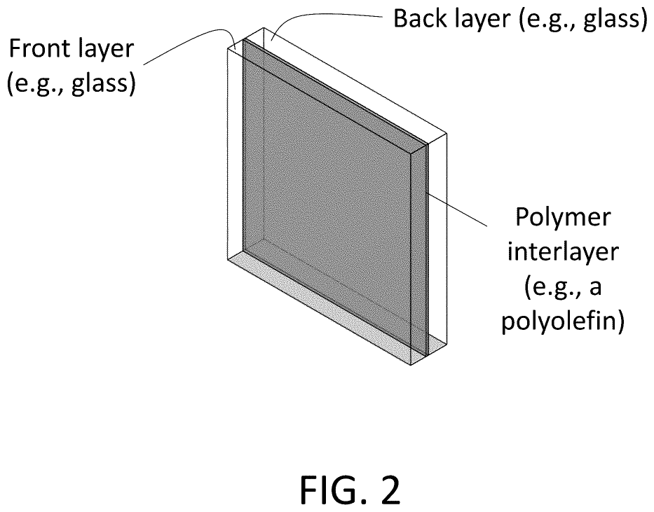

As noted above, the present methods have been illustrated above with respect to a PV panel, but are more generally appliable to a variety of multilayer structures comprising solid layers and polymer interlayers therebetween. Such a multilayer structure is illustrated in FIG. 2. Although not shown in this figure, other material layers, e.g., semiconductor layers, conductive layers, etc., may be positioned between the front layer and the polymer interlayer.

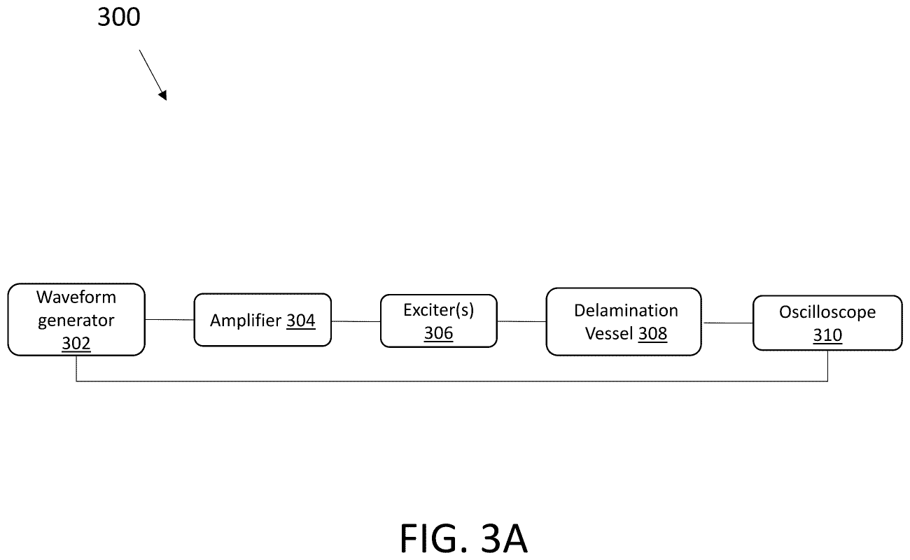

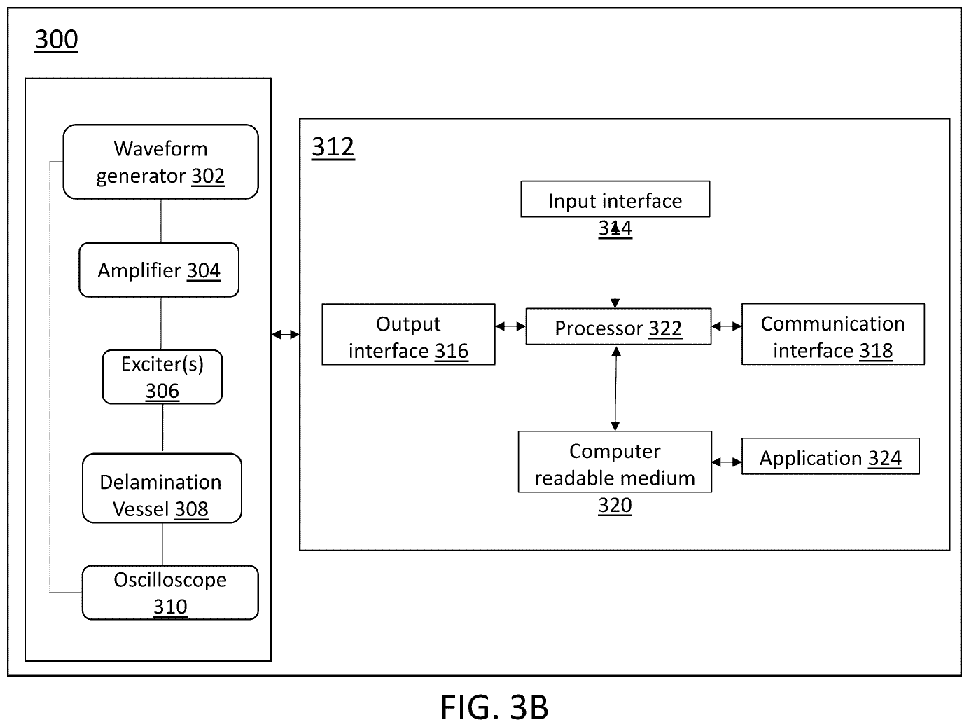

The present disclosure also provides delamination systems configured to carry out the present methods. An illustrative delamination system 300 is shown schematically in FIG. 3A. The delamination system 300 includes a waveform generator 302, an amplifier 304, an exciter 306, a delamination vessel 308, and an oscilloscope 310. Any of the sources described above may be used as the exciter 306 and specific illustrative electromagnetic exciters are described in the Example, below. The exciter 306 is mounted to the delamination vessel 308 so as generate sound waves therein, the frequency and power of which are controlled by the waveform generator 302 (configured to provide an input waveform to drive the exciter 306) and the amplifier 304 (configured to amplify the input waveform), respectively. The delamination vessel 308 is configured to contain a liquid medium and a sample at least partially immersed therein. A piezoelectric chip may be mounted to the sample within the delamination vessel 308. The piezoelectric chip may be in electrical communication with the oscilloscope 310 to provide a response signal that allows for visualization and measurement of vibrations of the sample induced by the propagating sound waves. In addition to an amplified signal applied to the exciter 306 via the input waveform, another phase-locked sinusoidal signal at the same frequency may be directly connected to the oscilloscope 310 as a trigger signal.

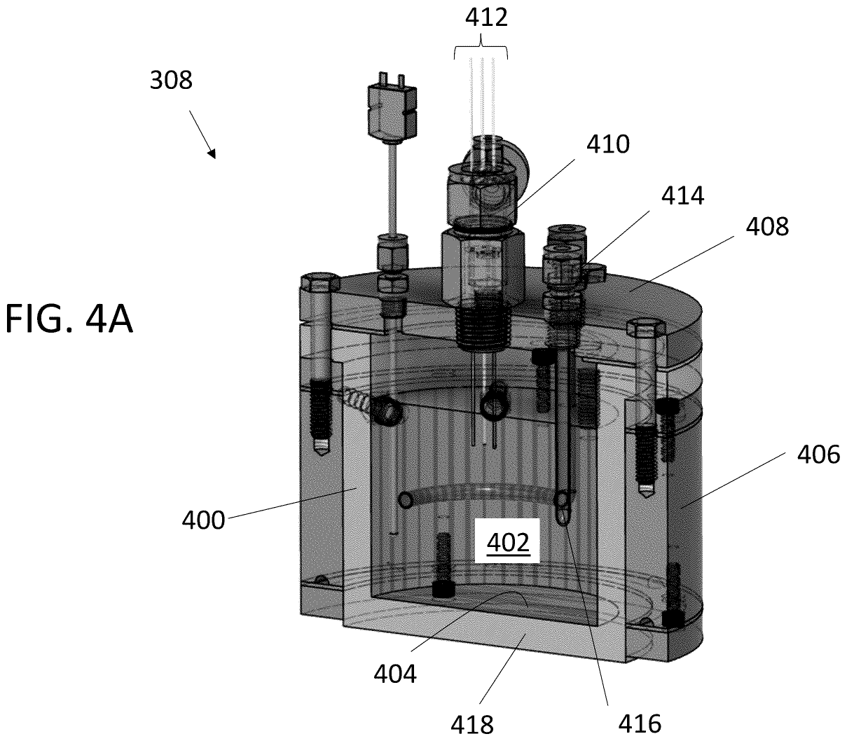

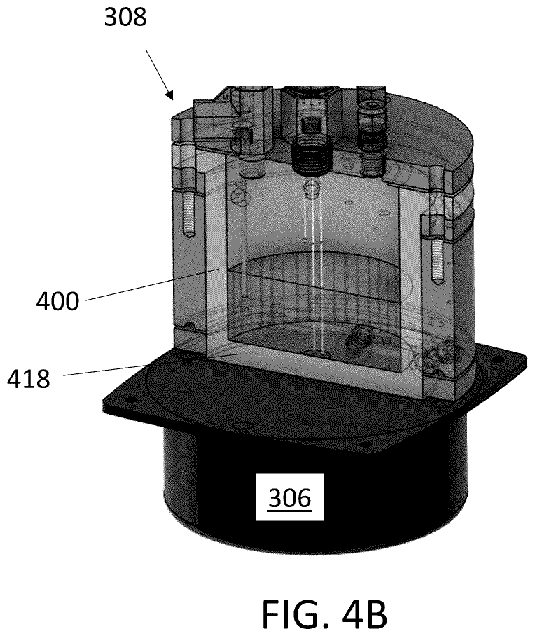

An illustrative delamination vessel 308 is shown in more detail in the cross-section of FIG. 4A. The delamination vessel 308 includes a high-density polyethylene (HDPE) housing 400 defining a cylindrically shaped interior chamber that contains a liquid medium 402. Not shown is the sample (and the piezoelectric chip mounted thereto) which may be placed in the interior chamber, e.g., at its bottom surface 404. A jacket 406 (e.g., aluminum) surrounds side walls of the HDPE housing 400. A lid 408 is mounted to the HDPE housing 400 and the jacket 406 to enclose the interior chamber and isolate it from the surrounding environment. A feedthrough assembly 410 allows poly(ethylene-co-tetrafluoroethylene) (ETFE)-insulated wires 412 to be inserted therethrough for electrical connections, including to the piezoelectric chip mounted to the sample. To heat the liquid medium 402, another feedthrough assembly 414 allows insertion of a metal tube 416 through which heat-exchange liquids circulate. A cross-section of the delamination vessel 308 is shown again in FIG. 4B, along with a perspective view of the exciter 306, which may be mounted directly to a bottom wall 418 of the HDPE housing 400 of the delamination vessel 308.

Because the present methods comprise the use of sound waves having at least two different frequencies, multiple sources (e.g., multiple exciters) may be used, each configured to generate acoustic waves of the appropriate frequency, profile, and power. For example, two exciters may be stacked and mounted directly to the bottom wall 418 of the HDPE housing 400 of the delamination vessel 308. Other mounting configurations may be used, including mounting exciters within the interior chamber of the delamination vessel 308.

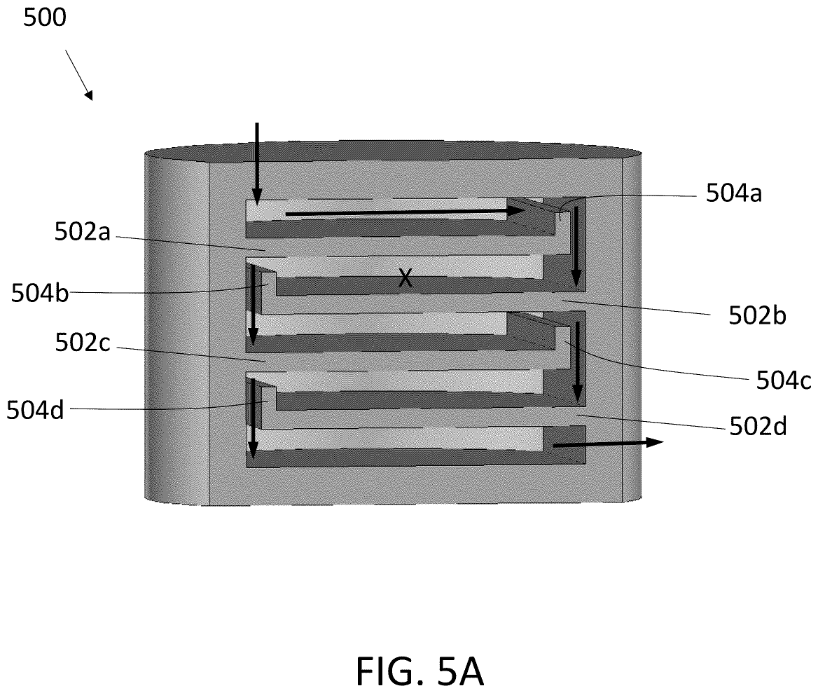

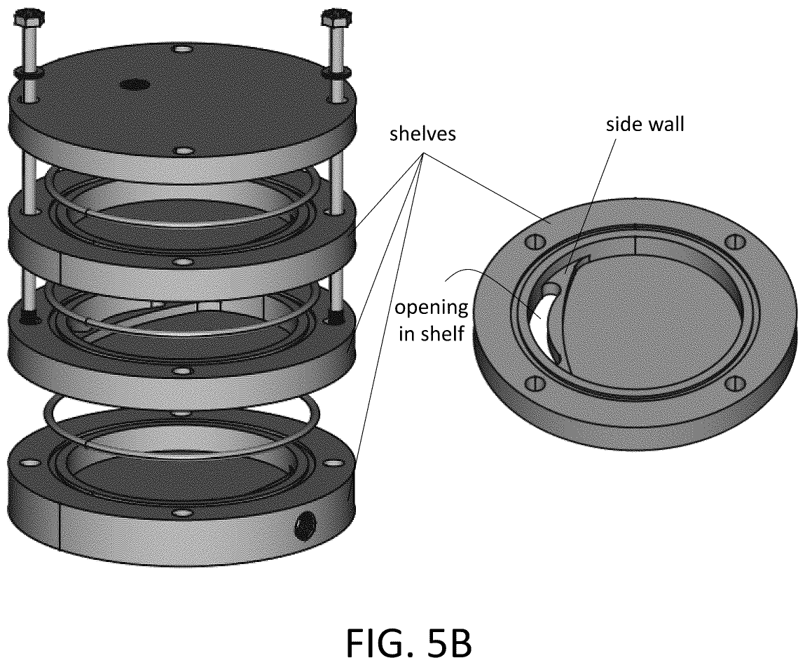

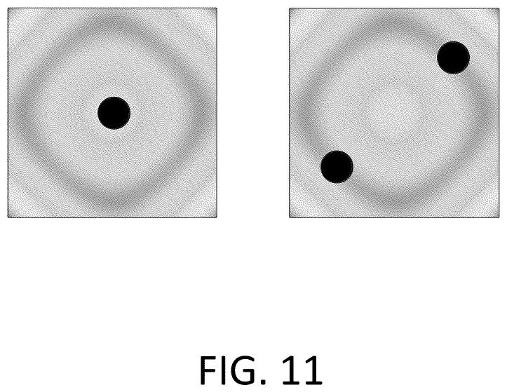

The illustrative delamination vessel 308 is configured to delaminate a single sample. However, other configurations may be used so that multiple samples may be delaminated at the same time. An illustrative such configuration is shown in FIG. 5A, which shows a cross-sectional view of a portion 500 of such a delamination vessel. In this embodiment, the delamination vessel includes multiple shelves 502a-d, on which individual samples may be positioned (as indicated by the X on shelf 502b). Openings are defined in each shelf 502a-d through which a liquid medium can flow as indicated by the multiple arrows. In addition, each shelf 502a-d has mounted thereto a wall 504a-d. The dimensions of these walls 504a-d are such that some of the liquid medium will be contained within each shelf 502a-d to at least partially immerse a sample positioned thereon, but some liquid medium may overflow to an underlying shelf as indicated by the multiple arrows. A perspective view of a similarly configured portion of a delamination vessel is shown in FIG. 5B. The delamination vessels shown in FIGS. 5A and 5B may include vibration controllers, such as springs, mounted therein. By way of illustration, vibration modes of a layer of a sample as shown in FIG. 11 are characterized by nodes as labeled with the filled circles in these figures. Springs may be mounted to any of the multiple shelves 502a-d at these node positions to further control desired vibration modes.

The delamination system 300 shown in FIG. 3A is illustrative and delamination systems for carrying out the present methods may include additional, fewer, different components, and/or different arrangements as compared to those shown in FIG. 3A. Regarding such additional components, as illustrated in FIG. 3B, a controller 312 configured to control one or more components of the delamination system 300 may be included. The controller 312 may be integrated into the delamination system 300 as part of a single device or its functionality may be distributed across one or more devices that are connected to other system components directly or through a network that may be wired or wireless. A database, a data repository for the delamination system 300, may also be included and operably coupled to the controller 312. Such a controller 312 may include an input interface 314, an output interface 316, a communication interface 318, a computer-readable medium 320, a processor 322, and an application 324. The controller 312 may be a computer of any form factor including an electrical circuit board. Regarding the application 324, it performs operations associated with controlling other components of the delamination system 300. Some of these operations may include receiving and/or processing data to be used while carrying out the present methods. Other of these operations may include controlling components of the delamination system 300 based on the data. Some or all of these operations may be controlled by instructions embodied in the application 324.

The input interface 314 provides an interface for receiving information into the controller 312. Input interface 314 may interface with various input technologies including, e.g., a keyboard, a display, a mouse, a keypad, etc. to allow a user to enter information into the controller 312 or to make selections presented in a user interface displayed on the display. Input interface 314 further may provide the electrical connections that provide connectivity between the controller 312 and other components of the delamination system 300.

The output interface 316 provides an interface for outputting information from the controller 312. For example, output interface 316 may interface with various output technologies including, e.g., the display or a printer for outputting information for review by the user. Output interface 316 may further provide an interface for outputting information to other components of the delamination system 300.

The communication interface 318 provides an interface for receiving and transmitting data between devices using various protocols, transmission technologies, and media. Communication interface 318 may support communication using various transmission media that may be wired or wireless. Data and messages may be transferred between the controller 312, the database, other components of the delamination system 300 and/or other external devices using communication interface 318.

The computer-readable medium 320 is an electronic holding place or storage for information, including the instructions and any process-specific parameters and universal constants to supplement the processing mentioned below, so that the information can be accessed by the processor 322 of the controller 312. Computer-readable medium 320 can include any type of random access memory (RAM), any type of read only memory (ROM), any type of flash memory, etc. such as magnetic storage devices, optical disks, smart cards, flash memory devices, etc.

The processor 322 executes instructions. The instructions may be carried out by a special purpose computer, logic circuits, or hardware circuits. Thus, the processor 322 may be implemented in hardware, firmware, or any combination of these methods and/or in combination with software. The term “execution” is the process of running an application 324 or the carrying out of the operation called for by an instruction. The instructions may be written using one or more programming language, scripting language, assembly language, etc. and stored in any form including source, intermediate representation, or binary. In embodiments, processor 322 executes an instruction, meaning that it performs/controls the operations called for by that instruction. In other embodiments, processor 322 executes an interpreter, virtual machine, etc. that parses, interprets, translates, etc. instructions in the forms of intermediate language, binary, etc. Processor 322 operably couples with the input interface 314, with the output interface 316, with the computer-readable medium 320, and with the communication interface 318 to receive, to send, and to process information. Processor 322 may retrieve a set of instructions from a permanent memory device and copy the instructions in an executable form to a temporary memory device that is generally some form of RAM.

The application 324 performs operations associated with controlling other components of the delamination system 300. Some of these operations may include generating frequency domain data according to a frequency sweep protocol to be used during delamination of a multilayer structure. Other of these operations may include controlling components of the delamination system 300 based on the generated data. Some or all of the operations described in the present disclosure may be controlled by instructions embodied in the application 324. The operations may be implemented using hardware, firmware, software, or any combination of these methods. With reference to the illustrative embodiment of FIG. 3B, the application 324 is implemented in software (comprised of computer-readable and/or computer-executable instructions) stored in the computer-readable medium 320 and accessible by the processer for execution of the instructions that embody the operations of application 324. The application 324 may be written using one or more programming languages, assembly languages, scripting languages, etc.

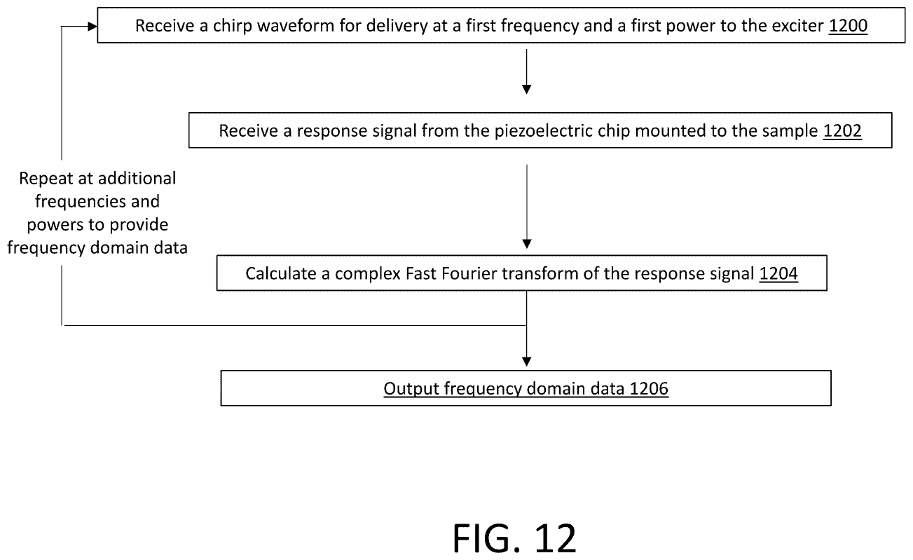

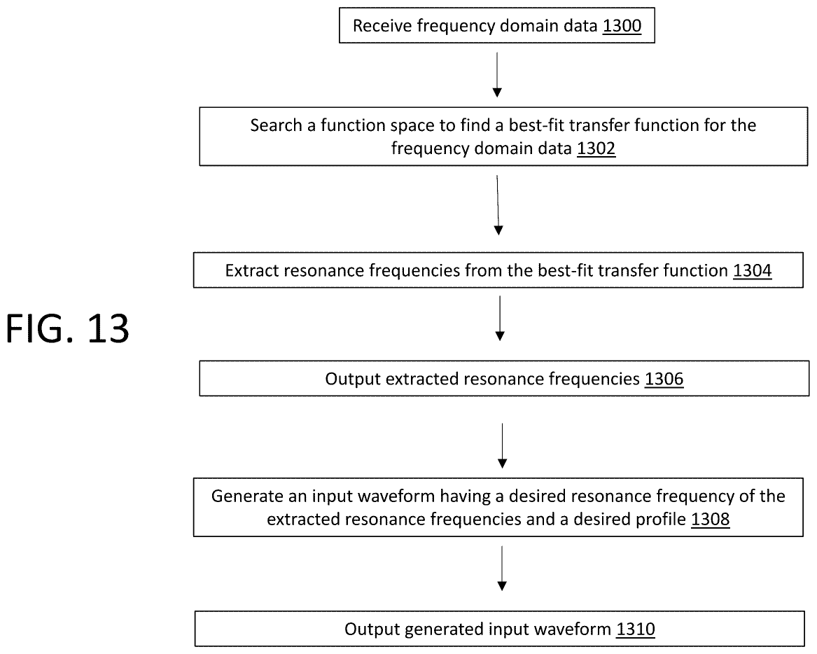

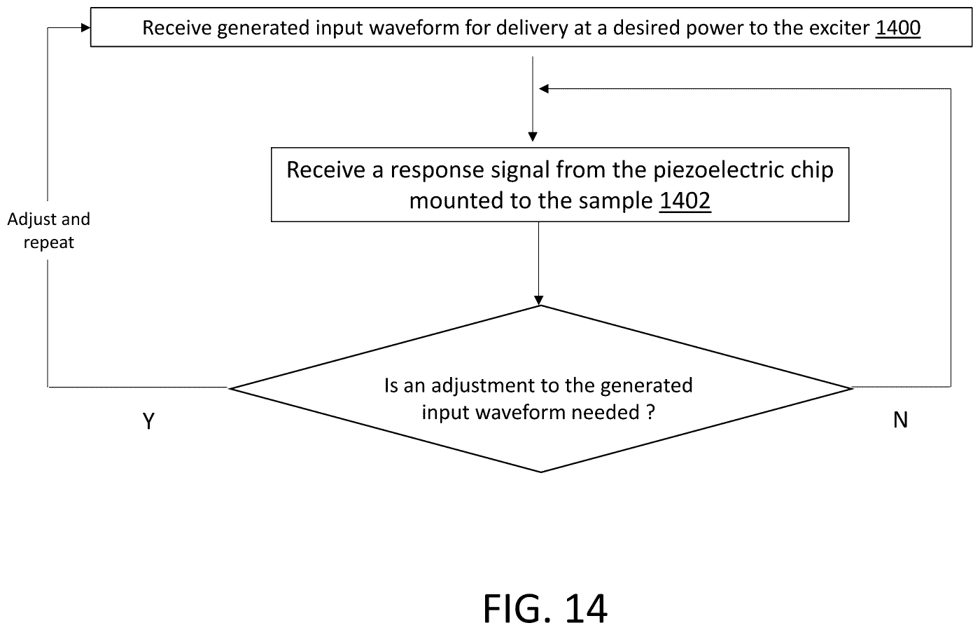

With reference to FIGS. 12-14, operations which may be associated with the application 312 are described according to illustrative embodiments. FIG. 12 relates to operations for generating the frequency domain data according to the frequency sweep protocol. FIG. 13 relates to operations for processing the frequency domain data. FIG. 14 relates to operations for controlling components of the delamination system 300 based on the generated and/or processed frequency domain data. In these figures, additional or fewer operations may be performed depending on the embodiment. Also, the order of the operations is not intended to be limiting. Thus, although some of the operational flows are presented in sequence, the various operations may be performed in various repetitions, concurrently, and/or in other orders than those that are illustrated.

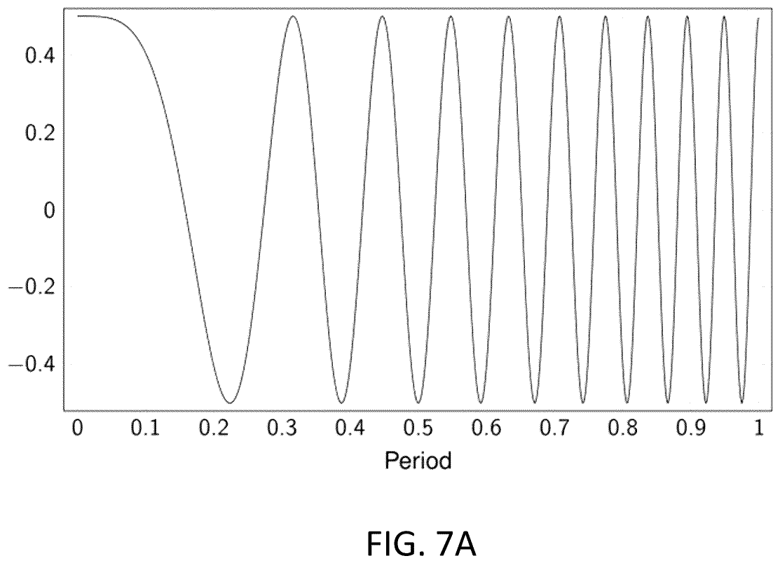

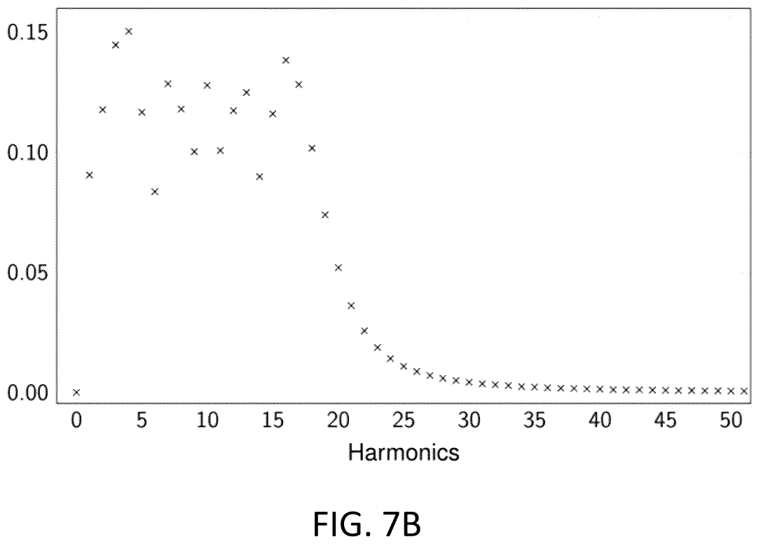

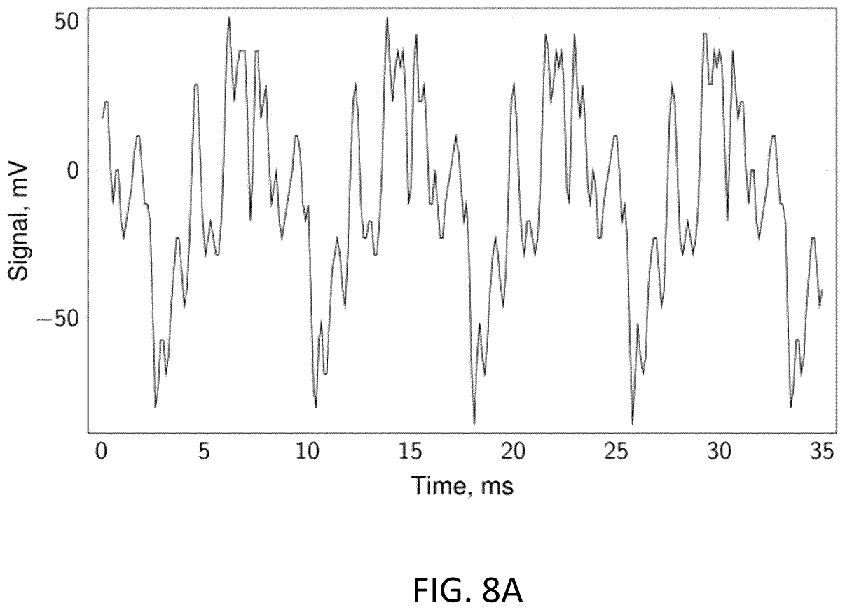

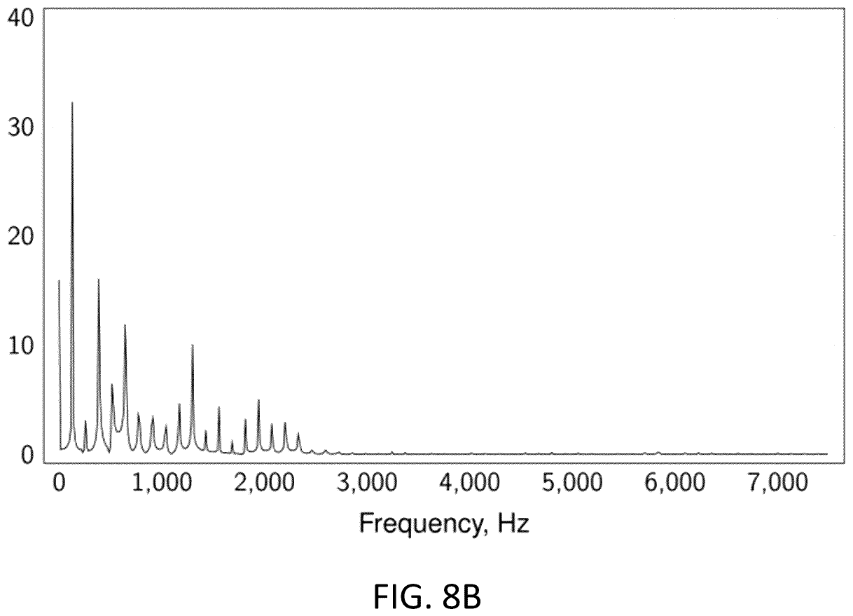

As noted above, FIG. 12 describes illustrative operations for generating the frequency domain data according to the frequency sweep protocol. In a first operation 1200, a chirp waveform (e.g., see FIG. 7A) is received by the waveform generator 302 for delivering the chirp waveform modulated at a first frequency and amplified to a first power to the exciter 306 (including via the amplifier 304). This generates propagating sound waves that ultimately impact a sample mounted in the delamination vessel 308, thereby inducing vibrations of the sample and the piezoelectric chip thereon. The chirp waveform (as well as the values of the first frequency and first power) may be input by a user via the input interface 314 or received by reading from the computer-readable medium 320 or the database (e.g., via the communication interface 318). In a second operation 1202, a response signal (e.g., see FIG. 8A) from the piezoelectric chip mounted to the sample is received by the processor 322 for processing. In a third operation 1204, a complex Fast Fourier transform of the response signal is calculated (e.g., see FIG. 8B). Operations 1200-1204 may be repeated at additional frequencies and powers (e.g., as input by a user or read from the computer-readable medium 320/database). Together the operations 1200-1204 may be referred to as the “frequency sweep protocol” and the collection of complex Fast Fourier transforms calculated from the response signals may be referred to as the “frequency domain data.” In a fifth operation 1206, this frequency domain data may be output, e.g., to the processor 322 for processing.

Next, FIG. 13 describes illustrative operations for processing the frequency domain data. In a first operation 1300, the frequency domain data is received by the processor 322. In a second operation 1302, a function space (e.g., as input by a user or read from the computer-readable medium 320/database) is searched to find a best-fit transfer function for the frequency domain data. (An illustrative function space and illustrative best-fit transfer functions are described in the Example, below.) In a third operation 1304, resonance frequencies (corresponding to certain units in the denominator of the best-fit transfer function) for the sample are extracted from the best-fit transfer function. In a fourth operation 1306, these resonance frequencies are output, e.g., to a display for evaluation and/or to the processor 322 for further processing. In a fifth operation 1308, an input waveform having a desired resonance frequency (e.g., a low or high resonance frequency as described above) and a desired profile (e.g., sinusoidal) is generated from the best-fit transfer function. In a sixth operation 1310, the generated input waveform is output, e.g., to the waveform generator 302. As described below with respect to FIG. 14, this generated input waveform may be used in controlling operation of various components of the delamination system 300 during delamination.

Finally, FIG. 14 describes illustrative operations for controlling operation of various components of the delamination system 300 during delamination based on processed frequency domain data. In a first operation 1400, the input waveform generated by operation 1308 is received by the waveform generator 302 for delivering the generated input waveform at a desired power to the exciter 306 (including via the amplifier 304). The desired power may be input by a user or read from the computer-readable medium 320/database. This generates propagating sound waves that ultimately impact a sample mounted in the delamination vessel 308, thereby inducing vibrations of the sample and the piezoelectric chip thereon. Due to the characteristics of the input waveform as generated by operation 1308, these sample vibrations occur at the desired resonance frequency and with the desired profile. In a second operation 1402, a response signal from the piezoelectric chip mounted to the sample is received by the processor 310 for evaluation and/or processing, including to ensure sample vibrations are occurring at the desired resonance frequency and with the desired profile. In a third operation 1404, a determination is made based on the results from the second operation 1402, as to whether an adjustment to the generated input waveform is required to ensure sample vibrations are occurring at the desired resonance frequency and with the desired profile. If the determination is no, operations 1402-1404 may be repeated for continued monitoring. If the determination is yes, the adjustment may be made and operations 1400-1404 may be repeated for continued monitoring. Together, operations 1400-1404 provide a “feedback loop” that enables dynamic adjustments of the sound waves being used in the delamination method.

FIGS. 13 and 14 have been described with respect to use of an input waveform to generate sounds waves of a certain frequency, profile, and power. However, as discussed above, the present systems and methods may use multiple sources (i.e., exciters). Thus, these multiple sources may each be involved in operations analogous to those described above with respect to delamination system 300 and the single exciter 306. Further regarding the use of multiple sources, phase differences with respect to a first source generating sound waves at a first frequency can be measured using piezoelectric chips positioned at intended locations for the additional sources. The frequency sweep protocol described above may be used to process response signals and adjustments made to input waveforms to minimize signal clashing.

It is noted that devices including the processor 322, the computer-readable medium 320 operably coupled to the processor 322, the computer-readable medium 320 having computer-readable instructions stored thereon that, when executed by the processor 322, cause the device to perform any of the operations described above (or various combinations thereof) are encompassed by the present disclosure. The computer-readable medium 320 is similarly encompassed.

It is noted that the frequency sweep protocol described above may be, but need not be, performed each time a delamination method is carried out. For example, the frequency sweep protocol may be performed once for a certain delamination system, delamination conditions, and type of multilayer structure (e.g., composed of certain types of layers having certain dimensions) to determine the resonance frequencies and input waveform for the multilayer structure. These resonance frequencies and input waveform may then be used to delaminate other similarly configured multilayer structures (i.e., composed of approximately the same layers and having approximately the same dimensions) using the same delamination systems and conditions.

### Example

### Introduction

The Example below describes delamination experiments conducted on samples composed of a front glass layer, a back glass layer, and a polymer interlayer (a polyolefin) in between. The samples had various lateral dimensions as detailed below, but were <6 cm. The delamination system, delamination methods, and results are described in detail below. The findings provide crucial insights into the delamination mechanism. Design strategies for upscaling the methods and for synchronization of multiple vibration sources are also described.

### Delamination System

A delamination system was designed and fabricated. The system is schematically shown as 300 in FIG. 3A and has been described above. Electromagnetic exciters that may be used as the exciter 306 include Dayton DAEX32EP-4 and Visaton EX 80 S. The trigger signal used a trigger threshold approximately 5% below its peak voltage. The delamination vessel 308 is shown in FIGS. 4A and 4B and has been described above.

### Frequency Responses of Dry Square Samples

Using the delamination system 300 described above, a first set of experiments was conducted to study the frequency response of dry (no liquid medium) square samples of various sizes at ambient conditions (22° C.). As noted above, voltage oscillations measured by the oscilloscope 310 are due to the vibrations experienced by the piezoelectric chip due to the propagating sounds waves, and thus, the sample. An input waveform having a sinusoidal profile was used for these experiments. The frequency from the waveform generator 302 was swept using a geometric progression from 100 Hz to 400 Hz with a ratio

$$\sqrt[8]{2} ( \approx 1.09051 ) .$$

Also, at a near-resonance frequency for each sample size (183.4 Hz for 55 mm, 129.7 Hz for 35 mm and 25 mm, and 118.9 Hz for 10 mm), the power output from the amplifier was varied using the following values: 7.1 W, 4.9 W, and 2.0 W. As the exciter used has about 30% efficiency in the delamination vessel 308, the actual sound wave power is about 30% of these values. During the frequency sweep, the measured voltage oscillations of the piezoelectric chip/sample were also sinusoidal, indicating that every stage of the system 300 behaved linearly. On a logarithmic (decibel) scale, the frequency responses of the samples were obtained by subtracting the background frequency response of the system 300 measured without any sample, using a power output of 7.1 W that provided the best signal-to-noise ratio. For a given set of operating conditions, the frequency responses of the samples measured demonstrated that while all sizes experienced similar a vibration frequency, the amplitude varies inversely with sample size.

### Nonlinear Sound Wave Transmission to the Samples in the Filled Delamination Vessel

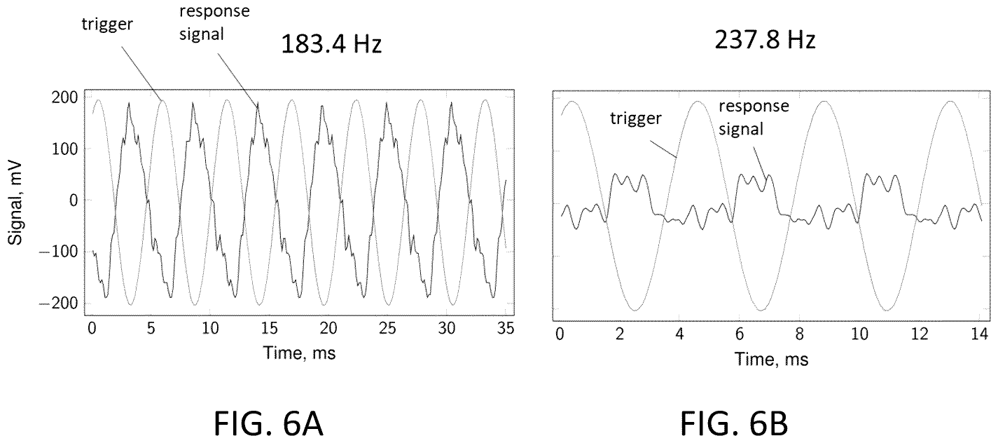

Unlike the situation described above for samples not in contact with a liquid medium, it was found that the vibrations of the samples when mounted in the interior chamber of the delamination vessel 308 filled with the liquid medium 402 (n-hexane) were distorted as compared to those being generated by the exciter 306 via the amplified input waveform. This is demonstrated in FIGS. 6A and 6B showing the trigger signal (equivalent to the input waveform sent to the amplifier 304 for driving the exciter 306) and the resulting response signal from the piezoelectric chip mounted to the sample. As shown in FIG. 6A, at 183.4 Hz, the trigger signal and the response signal are similar, but as shown in FIG. 6B, at 237.8 Hz, the difference between the trigger signal and the response signal shows that the transmitted energy from the propagating sound waves is attenuated and dispersed across multiple frequencies, including ones that may not be effective for delamination. For example, using identical conditions (50° C., 350 mL n-hexane as the liquid medium, 29 W power), a 55 mm square sample was shattered when using the 183.4 Hz incident sinusoidal wave in 20 min, while no substantial change (i.e., no breakage or delamination) was observed using the 237.8 Hz incident sinusoidal wave after 40 min.

### Empirical Numerical Modeling of Sound Wave Transmission

In view of the nonlinear sound wave transmission to samples as described above, additional experiments were conducted to examine the correlation between input signals (input waveform) and measured sample vibrations (response signal). These experiments also allow for the determination of the resonance frequencies of the samples as well as the input waveform required to generate sample vibrations at those resonance frequencies. Using the delamination vessel 308, the experiments made use of square samples (55 mm) immersed in 350 mL n-hexane at 50° C. Establishing correlations between sinusoidal input waveforms and response signals using measurements from a frequency sweep between 100 Hz and 400 Hz, and varying the power output at 8 W, 19 W, and 29 W, proved challenging, further confirming the complex, nonlinear interaction of sound waves within the liquid medium 402 of the delamination vessel 308. Thus, chirp waveforms were used as the input waveform for additional experiments.

Chirp waveforms are frequently used as input waveforms when studying complex systems in signal processing theory, as characterized by its modulated frequency over time, y=cos[w(t)t+ϕ]. (See Easton, R. L., Jr., Fourier Methods in Imaging, Wiley, 2010.) For simplified arithmetic handling, its complex form, \tilde{y}=exp[ [symbol] w(t)t+ [symbol] p], and complex Fast Fourier Transform (FFT) were used. For these experiments, a 16-bit, 16384-point sample of a chirp waveform (see FIG. 7A) was used in the waveform generator 302. As shown in FIG. 7B, a magnitude plot obtained by the complex FFT of this chirp waveform showed that repeating this waveform at a certain frequency (f) additionally provides information for at least 16 harmonics (2f to 17f), where a signal component at a multiple (kf) of the fundamental frequency (f) is frequently called the kth harmonic. Also, the complex FFT provides the coefficients, \tilde{z}ₖ, in a Fourier sequence,

$$\tilde{y} = {\sum }_{k = 1}^{N} {\tilde{z}}_{k} exp ( {𝕚ω}_{k} t ) ,$$

to simplify the analysis using well-established Python packages, numpy and scipy. Here ωₖ=2πkf.

Using the abovementioned frequency sweep and varied power outputs (i.e., a frequency sweep between 100 Hz and 400 Hz, and power outputs at 8 W, 19 W, and 29 W), response signals were measured and frequency-domain datasets were calculated from the measured response signals using complex FFT. An example of a measured response signal is shown in FIG. 8A using a 129.7 Hz chirp waveform as the input waveform. Specifically, the chirp waveform of FIG. 7A was scaled to a desired peak-to-peak voltage, and the chirp waveform was repeated at a rate of 129.7 periods per second. The magnitude plot of the complex FFT of the measured response signal is shown in FIG. 8B. The heights of the peaks are equivalent to the moduli of the coefficients, |\tilde{z}ₖ|, in the Fourier sequence corresponding to FIG. 8A. Between the Fourier sequences of the corresponding inputs and outputs using volt (V) as the unit, the best-fit transfer function was searched in a function space consisting of the following forms,

$$\frac{{p}_{N} ( \tilde{z} )}{1 + {( \frac{f - a}{b} )}^{2}} , \frac{{p}_{N} ( \tilde{z} )}{b + {( f - a )}^{2}} , \frac{{p}_{N} ( \tilde{z} )}{{( f - a )}^{2}} , \frac{{p}_{N} ( \tilde{z} )}{f - a}$$

where p_{N}(\tilde{z}) is an Nth-order complex-coefficient polynomial of \tilde{z} and f (Hz) is the frequency corresponding the coefficients \tilde{z} (V) in the complex Fourier sequence. The best-fit transfer function was found to be as follows:

$$\frac{\begin{matrix}( - 0.887909 + 1.065176 j ) {z}^{1} + ( 166.1999 + \\ 484.5411 j ) {z}^{2} - ( 1709.028 + 903.587 j ) {z}^{3}\end{matrix}}{7.0370899 + {( f - 81.379366 )}^{2}} + \frac{\begin{matrix}( 0.04332 + 0.540549 j ) {z}^{1} - ( 72.48876 + \\ 99.21269 j ) {z}^{2} - ( 17.06113 + 72.65203 j ) {z}^{3}\end{matrix}}{7.93934 + {( f - 99.923213 )}^{2}} + \frac{( 10.771098 - 6.493816 j ) {z}^{1} + ( 10.636904 + 8.997722 j ) {z}^{2}}{0.067543 + {( f - 167.297652 )}^{2}}$$

Since the oscilloscope 310 uses 16-bit A/DCs, only digits that finally evaluate above 1 μV are significant. This denominator of the best-fit transfer function includes the three resonance frequencies of the system: 81.4 Hz, 99.9 Hz, and 167.3 Hz. Using the equation, \tilde{z} values may be solved at the harmonic frequencies, and a Fourier sequence is then assembled into an input waveform that leads to the desired vibrations, such as nearly sinusoidal ones, at the desired resonance frequencies.

Further, the effect of the input waveform on energy dispersion and attenuation of measured response signals was demonstrated. An input waveform was generated using the foregoing results, normalized and encoded following the waveform generator's 302 requirement. Although signals exerted on the exciter 306 had nearly identical power (and root-mean-square voltage), the measured response signals showed various extents of canceling interferences by harmonic vibrations, which were sampled around 15-16 min after starting the vibrations. Consequently, the rates of glass shattering and delamination of samples were quite different, depending upon whether a sinusoidal input waveform was used or an input waveform that generates a sinusoidal measured response signal was used.

While an empirical approach to discern the complex interactions associated with energy dispersion and attenuation was demonstrated for 55 mm square samples, the rate of polymer interlayer removal and the extent of glass shattering were also found to correlate with the intensity of measured response signals. Shattered back glass allows more surface area for the liquid medium to penetrate the polymer interlayer, which makes it difficult to evaluate an intrinsic removal rate.

### Effect of Delamination Temperature and Annealing

Experiments were conducted to evaluate the influence of delamination temperature and to minimize glass cracking and shattering. Experiments showed that when using a sound wave frequency of 129.7 Hz, glass shattering occurred at a delamination temperature of 50° C. and a power of 29 W. Glass shattering was reduced by increasing the delamination temperature to 60° C. and decreasing the power to 21 W. Glass shattering was further reduced by further decreasing power to 16 W.

Additional experiments showed that when the delamination temperature was increased to 70° C., the correlation between the input waveform and measured response signals was substantially different from the correlation at lower temperatures. Following the same frequency sweep protocol described above, at a delamination temperature of 70° C., the best-fit transfer function was found to be:

$$\frac{\begin{matrix}( - 0.090009 + 0.076192 j ) {z}^{1} + ( 1.315149 - \\ 2.162564 j ) {z}^{2} + ( 0.189312 + 0.18721 j ) {z}^{3}\end{matrix}}{1 + {( \frac{f - 87.816088}{30.840968} )}^{2}} + \frac{\begin{matrix}- ( 1.702083 + 18.02139 j ) {z}^{1} + ( 3.645558 + \\ 2.375884 j ) {z}^{2} + ( 0.195614 + 0.196285 j ) {z}^{3}\end{matrix}}{1 + {( \frac{f - 180.388335}{1.988768} )}^{2}} + \frac{( 0.152852 + 0.043395 j ) {z}^{1} - ( 11.86371 + 45.4564 j ) {z}^{2}}{1 + {( \frac{f - 281.760805}{48.333946} )}^{2}}$$

As compared to the best-fit transfer function found at 50° C. in the previous section, at 70° C., the responses decay slower around the resonance frequencies. This may be due to further softening of the polyolefin of the polymer interlayer, leading to more smearing between vibration modes. At 70° C., the resonance frequencies (87.8 Hz, 180.4 Hz, and 281.8 Hz) were also shifted to higher values. They almost form an arithmetic progression, suggesting that they may be related to harmonic vibration modes. In addition, the resonance frequency at 99.9 Hz found at 50° C. seems to have disappeared at 70° C. Cracking and shattering of the back glass layer was also reduced by increasing the delamination temperature, suggesting that the stress has been reduced by further softening the swollen polyolefin.

Additional experiments were conducted, the results of which suggested that an annealing step using a relatively high temperature may mitigate the stress on glass layers caused by polyolefin swelling and dissolution, thereby minimizing glass layer cracking and shattering. These experiments showed that glass cracking was fundamentally related to the relative rates of liquid medium-induced swelling and softening of the polyolefin, which are controlled by the rates of mass transfer through the four 0.3 mm (thickness)×55 mm edges and heat transfer across the two (55 mm)² lateral surfaces, respectively. In one set of experiments, the sample and the liquid medium 402 (n-heptane) were loaded into the delamination vessel 308. Heating started from ambient temperature (17-19° C.). An annealing temperature setpoint was first set to 30° C. and then raised stepwise by 10° C. The setpoint was held at each value for either 10 min or 20 min. A cracking sound was heard during this process. In another set of experiments, only n-heptane was loaded into the delamination vessel 308. Heating started from ambient temperature. An annealing temperature setpoint was set to 70° C. and equilibrated. A sample was loaded and pretreated in 70° C. n-heptane for 1 hour. No cracking was observed in this process.

Cracking is likely the cumulative result of two phenomena: (a) the relatively hard polyolefin (compared to the softened polyolefin ≥60° C.) is isotropically swollen by the n-heptane and deforms the glass, and (b) the resonant vibration of the glass at frequencies <100 Hz induces further internal stress. If the polyolefin is softer prior to exposure to propagating sound waves, it can expand in one dimension and avoid exerting too much stress on the glass layers. At slightly higher temperatures (55-60° C.) within the likely melting range of the polyolefin, n-heptane is a better solvent than n-hexane due to its lower vapor pressure and possibly higher affinity to polyolefins. However, at higher temperatures (˜70° C.), the polyolefin may become so soft that the vibrations are damped and ineffective to facilitate delamination. Further, the polyolefin also becomes very sticky without being adequately soluble in the liquid medium. As a result, the polyolefin can be removed up to ˜2 mm from the edges of the sample, but longer treatment does not further remove any polyolefin.

Experiments were conducted in which the sample was first annealed in n-heptane at 70° C. for 1 hour as described above. Next, the sample was exposed to sound waves produced from the exciter 306 using an input waveform that ensured sinusoidal sample vibrations at either a resonance frequency of 91.7 Hz or a near-resonance frequency of 1414.2 Hz. The delamination time was 20 minutes. Separate exciters were used for each frequency, one optimized for frequencies from 10⁰ to 10² Hz and the other optimized for frequencies from 10² to 10⁴ Hz. Two other frequencies near the lower resonance frequency were also evaluated. The results are shown in Table 1, below. At the lower resonance frequency, the polyolefin was removed, but only from the edges at a sluggish rate. Higher frequencies achieved negligible removal.

TABLE 1
Delamination experiments using a single frequency.

| Delamination | Applied | Applied | Removal depth |
|---|---|---|---|
| Temperature | Frequency | Power | from edges of |
| (° C.) | (Hz) | (W) | sample (mm) |
| 56 | 91.7 | 21 | 0.92-1.24 |
| 52 | 91.7 | 21 | 0.46-0.61 |
| 48 | 91.7 | 21 | ~0.3 |
| 48 | 100.0 | 21 | 0.63-0.85 |
| 52 | 100.0 | 21 | 0.3-1.09 |
| 52 | 109.1 | 21 | Negligible |
| 48 | 109.1 | 21 | Negligible |
| 48 | 1414.2 | 1.6 | Negligible removal |
| | | | from edges, but the |
| | | | interlayer started to |
| | | | crack as illustrated in |
| | | | FIG. 9 bottom left |
| 48 | 1414.2 | 1.6 | Same as above |
| 48 | 1414.2 | 1.6 | Same as above |
| 52 | 1414.2 | 1.6 | Same as above |

### Insights and Optimization of Delamination for Samples≤55 mm

The following conclusions emerged clearly from the experiments and results described above. Harmonics are generated as sound waves propagate from their source (e.g., exciter 306) to samples immersed in n-hexane or n-heptane as the liquid medium 402. Harmonics from primary frequencies <200 Hz are particularly strong. The findings suggest that the vibration modes associated with frequencies in this range correspond to bending modes of the glass layers, which are induced by transverse sound waves. Because transverse sound waves cannot be transmitted through bulk fluids, nonlinear behavior is likely due to transmission through unsteady contacts of solids, e.g.,—at each point of contact between the swarf and the bottom of the vessel wherein the motion directions are not synchronized when the excitation frequency deviates from a resonance frequency. Temperature affects the phase transition (from rigid solid to softer solid) and elasticity of the polymer interlayer and consequently, the extent of wave damping. The application of a single low or high frequency sinusoidal sound wave causes slow delamination.

Using a single frequency of around 1-2 kHz, the sample does not experience a vibration at any lower frequency and was not delaminated within a few hours. However, when a sinusoidal excitation at a single frequency of around 10² Hz is used, the sample also experiences harmonics around 1-2 kHz and some delamination occurs on the order of tens of minutes. Although a single kHz frequency does not efficiently delaminate the samples, delamination may be induced by a combination of fundamental and harmonic frequencies acting on the sample synergistically.

Regarding liquid media, n-hexane is superior among C₄-C₁₂ linear alkanes, toluene, and CO₂ at 50° C. Although n-heptane is slightly less effective than n-hexane, its substantially lower vapor pressure may benefit process and equipment design and reduce equipment cost. The use of n-heptane as solvent is also demonstrated below. Because 50° C. is slightly below the melting temperatures of the amorphous regions in a polyolefin interlayer, higher temperatures can be used in an annealing step to soften the polyolefin and reduce the stress that causes cracking of the tempered glass layers.

Control of the experimental parameters used during delamination is achieved by mounting a piezoelectric chip to the sample to measure the vibrations of the sample induced by the propagating sound waves inside the delamination vessel 308. This also enables determination of the resonance frequencies of any particular sample under various conditions (e.g., liquid medium, delamination temperature) by empirical modeling of sound wave transmission as described above. The piezoelectric chip and the delamination system 300 configured as shown in FIGS. 3A-3B further provide a feedback loop in which the measured response signals can be monitored to ensure they have the desired profile (e.g., sinusoidal) and the desired frequencies and the input waveform driving the exciter 306 can be adjusted dynamically based on deviations from the desired profile/frequencies.

As illustrated in FIG. 9, the experiments suggest that glass bending vibration modes, induced by transverse sound waves, correspond to low resonance frequencies and aid in polyolefin removal from sample edges. Polymer interlayer compression vibration modes, induced by longitudinal sound waves, appear to correspond to high resonance frequencies. The Poisson effect of such vibrations on an appropriately softened material likely causes fatigue in the polyolefin (similar to corrosion fatigue of metals/alloys). Although faster than using only liquid medium and no sound waves, using a single resonance frequency (and thus, inducing only one of the two vibration modes) does not result in efficient delamination. In contrast, an appropriate combination of both vibration modes results in fast delamination. Such a combination may loosen the edges of the polyolefin, resulting in the mass transport of the liquid medium through the polyolefin being more convective than diffusive. Such penetration may open up flow channels in the polyolefin, likely allowing the C—H bonds in the penetrating liquid medium to replace such bonds in the polyolefin itself via van der Waals interactions, preventing the polyolefin separated by shearing from sticking back together.

FIG. 10 provides a visual illustration of the various vibration modes and their resonance frequencies of a sample having lateral dimensions of 24.6 mm and a polymer interlayer having the same lateral dimensions (left image). The intensity plots show a top view of the vibration modes and the resonance frequencies of these modes are qualitatively mapped onto the adjacent frequency scale. FIG. 10 further shows that the resonance frequencies of these vibration modes can change and new vibration modes appear as the lateral dimensions of the polymer interlayer change (right image). As noted above, the present methods and systems may include a feedback loop configured to dynamically adjust characteristics of the propagating sound waves (e.g., frequency, power, profile) based on a dynamically changing sample.

### Delamination of Nearly Square Samples

Based on the findings summarized above, another set of experiments was conducted as follows. First, about 150 mL n-heptane was loaded into the delamination vessel 308 which was then purged and heated to 65-70° C. Next, the sample was placed into the delamination vessel 308, which was then purged and heated back to 65-70° C. This temperature was held for 60 min for samples >˜40 mm or 30 min for samples ˜30 mm. Next, the temperature was lowered to ˜56° C. and a frequency sweep protocol was performed as described above. The frequency sweep protocol enabled the determination of the resonance frequencies of the samples and the input waveform required to generate sinusoidal sample vibrations at those resonance frequencies. Next, sound waves were propagated through the n-heptane at a low resonance frequency and at a high resonance frequency for 20 minutes. Next, the delamination vessel 308 was opened to examine the sample. If necessary (due to incomplete delamination), the sample was reloaded and sound waves were propagated through the n-heptane at a low resonance frequency and at a high resonance frequency for another 20 minute cycle. Following delamination, if a delaminated glass layer had any remaining polyolefin, it was removed by immersing in hot (>55° C.) n-hexane or n-heptane for 10 min. The time can be reduced to 2-3 min using 20 kHz ultrasound. In these experiments, the mixture of n-heptane and polyolefin was filtered, and the n-heptane was reused, replenishing the amount lost on wetted surfaces. The results are shown in Table 2, below.

The first row in Table 2 is an evaluation of using a single exciter and the “beating” phenomenon between two oscillations at angular frequencies of ω₁ and ω₂. The superposition is equivalent to an oscillation at

$$\frac{{ω}_{1} + {ω}_{2}}{2}$$

while its intensity also oscillates at

$$\frac{{ω}_{1} - {ω}_{2}}{2} ,$$

where is algebraically

$$cos ( {ω}_{1} t ) + cos ( {ω}_{2} t ) = 2 cos ( \frac{{ω}_{1} + {ω}_{2}}{2} t ) cos ( \frac{{ω}_{1} - {ω}_{2}}{2} t ) .$$

As shown in Table 2, this resulted in slow delamination.

All remaining rows in Table 2 made use of two stacked exciters mounted to the delamination vessel 308 as shown in FIG. 4B. One exciter was optimized for frequencies from 10⁰ to 10² Hz and the other was optimized for frequencies from 10² to 10⁴ Hz. The two exciters were operated simultaneously. All samples were fully delaminated except for the samples in the last two rows. The ˜31×47 mm² sample showed delamination but with cracked glass. The ˜30×47 mm² sample was not delaminated and cracked glass was observed.

TABLE 2
Delamination experiments using dual frequencies.

| | Resonance frequencies | |
|---|---|---|
| | (Hz); applied frequencies | Delamination |
| Sample Size | shown in bold (power) | time × Cycle |
| ~57 × 58 mm² | 88, 258, 740, 1295, 1745* | 20 min × 6 |
| | *Instead of resonance | |
| | frequencies, 1250 and 1340 | |
| | were used (3.1 W) | |
| ~55 × 57 mm² | 90 (7.4 W), 274, 748, | 20 min × 2 |
| | 1297 (1.7 W), 1680 | |
| ~54 × 58 mm² | 90 (7.0 W), 247, 895, 1050, | 20 min × 3 |
| | 1210 (1.7 W), 1780 | |
| ~56 × 52 mm² | 92 (7.0 W), 185, 886, | 20 min × 3 |
| | 1250 (1.7 W), 1760 | |
| ~55 × 53 mm² | 91 (7.0 W), 192, 270, 830, | 20 min × 3 |
| | 1305 (1.6 W), 1925 | |
| ~43 × 49 mm² | 211 (4.7 W), 286, 1160, | 20 min × 2 |
| | 1310 (1.8 W), 1595, 1970 | |
| ~31 × 33 mm² | 410 (4.6 W), 810, | 20 min × 1 |
| | 1200 (1.8 W), 1560, 1945 | |
| ~32 × 38 mm² | 185, 475 (4.5 W), 630, 740, | 20 min × 2 |
| | 870, 1105 (1.8 W), 1690, | |
| | 1850 | |
| ~33 × 35 mm² | 397 (4.7 W), 805, | 20 min × 1 |
| | 1215 (1.8 W), 1580, 1975 | |
| ~29 × 51 mm² | 65, 96, 166, 219, 274, 362, | 20 min × 2 |
| | 470 (4.5 W), 572, 655, 870, | |
| | 1185 (1.8 W), 1595, 1960, | |
| | 2410 | |
| ~32 × 68 mm² | 42, 90, 143, 190, 294, | 20 min × 3 |
| | 337 (4.0 W), 455, 605, 835, | |
| | 1240 (1.8 W), 1580, 2120 | |
| ~31 × 47 mm² | 82, 99, 192, 283 (4.7 W), | 20 min × 3 |
| | 370, 495, 595, 685, 900, | |
| | 1205 (1.8 W), 1615, 1905, . . . | |
| ~30 × 47 mm² | 85, 103, 189 (4.8 W), 279, | 20 min × 1 |
| | 385, 490, 600, 680, 910, | |
| | 1180 (1.8 W), 1.45-1.55 kHz | |
| | (a broad band with no | |
| | obvious peak), 1805 | |

As compared to the results shown in Table 1, the results shown in Table 2 clearly demonstrate the synergistic effect of using dual frequencies on achieving efficient and effective delamination. All samples having a size <6 cm were efficiently delaminated at a rate of 0.2-0.4 hour/cm.

### KEY FINDINGS AND CONCLUSIONS

This Example has demonstrated several key findings and conclusions, including the following: The cracking of samples larger than 1″ was likely caused by the cumulative stress induced by the swelling of the relatively hard polyolefin interlayer near its edges and bending vibrations of the surrounding glass layers. This stress can be reduced by first annealing the polyolefin interlayer at ˜70° C. before exposure to the sound waves inducing the bending vibrations. The annealing helps to soften the polyolefin interlayer and thereby reduces the stress exerted on the glass by the polyolefin. The heat transfer rate achieved during annealing the polyolefin interlayer to soften it is much faster and uniform across the sample. In contrast, the penetration of the solvent into the interlayer (i.e., the mass transfer rate) occurs from the edge and its rate is much slower.

Nearly square samples in the 30-60 mm range have at most 6 resonance frequencies in 50-2000 Hz. Compared to such samples, rectangular samples in the last five rows of Table 2 do not have a 90° symmetry or frequency degeneracy of certain modes. Hence, a vibration mode with its wavelength along the longer dimension is generally expected to have a lower frequency than one along the shorter dimension. As determined by a frequency sweep protocol, the number of resonance frequencies in 50-2000 Hz increased to 13 or more for rectangular samples. Among the non-degenerate frequencies corresponding to glass bending vibration modes, the lower ones are more prone to cracking the glass than the higher ones.

Likely due to different strengths of polyolefin-alkane interactions, n-heptane is a better solvent than n-hexane at ˜56° C., which is also closer to the average of the melting range of the polyolefin.

Sound wave transmission in the delamination vessel from the source (exciter) to the samples is a complex, nonlinear process. As such, the input waveform for the exciter is a crucial parameter that is desirably controlled to promote delamination with minimal glass cracking and shattering.

The low and high resonance frequencies are likely associated with glass bending vibration modes (induced by transverse sound waves) and polymer interlayer compression vibration modes (induced by longitudinal sound waves), respectively. The low resonance frequencies show strong dependence on the size and shape of the glass layers. The high resonance frequencies vary subtly and may only depend upon the elasticity (affected by temperature) and the thickness of the polymer interlayer.

The synergistic effect enabled by using dual (low and high) resonance frequencies achieves faster and more effective delamination as compared to using either a low or high resonance frequency.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

Unless otherwise indicated, the term “type” as used herein refers to chemical formula such that a single type means the same chemical formula and different type means different chemical formula. Similarly, use of “more” as in “one or more” refers to use of different types of the relevant entity.

Throughout the present disclosure, terms such as “comprising” and the like may be replaced with terms such as “consisting” and the like.

What is claimed is:

1. A method for delaminating a multilayer structure, the method comprising exposing a multilayer structure in contact with a liquid medium to sound waves characterized by a first frequency and sound waves characterized by a second, different frequency, the multilayer structure comprising a solid front layer, a solid back layer, and a polymer interlayer comprising a polymer in between the solid front layer and the solid back layer, wherein the exposure separates the solid front layer, the solid back layer, the polymer interlayer, or combinations thereof from the multilayer structure.

2. The method of claim 1, wherein the solid front layer and the solid back layer are each composed of glass.

3. The method of claim 2, wherein the polymer interlayer comprises a polyolefin, an ethylene-vinyl acetate copolymer, a polyester, polyethylene terephthalate, polyethylene naphthalate, polyvinyl fluoride, or a combination thereof.

4. The method of claim 1, wherein the multilayer structure is a photovoltaic panel.

5. The method of claim 1, wherein the liquid medium comprises a linear alkane.

6. The method of claim 1, wherein the liquid medium comprises a mixture of CO₂ and a linear alkane or a mixture of linear alkanes.

7. The method of claim 1, wherein the liquid medium comprises n-hexane, n-heptane, or both.

8. The method of claim 1, wherein the first frequency and the second, different frequency are each a resonance frequency of the multilayer structure.

9. The method of claim 1, wherein the first frequency corresponds to a transverse sound wave that induces a bending vibration mode in one or both of the solid front layer and the solid back layer and the second, different frequency corresponds to a longitudinal sound wave that induces a compression vibration mode of the polymer interlayer.

10. The method of claim 1, wherein frequencies of the sound waves, including the first frequency and the second, different frequency are less than 1500 Hz.

11. The method of claim 10, wherein the frequencies of the sound waves are in a range of from 500 Hz to 1500 Hz.

12. The method of claim 1, wherein the multilayer structure is exposed to the first frequency and the second, different frequency simultaneously.

13. The method of claim 1, further comprising, prior to the exposing step, heating the multilayer structure in contact with the liquid medium at an annealing temperature that is greater than a delamination temperature used during the exposing step.

14. The method of claim 1, further comprising, prior to the exposing step, conducting a frequency sweep protocol to determine resonance frequencies of the multilayer structure, the resonance frequencies comprising the first frequency and the second, different frequency, and to generate an input waveform for driving a source of the sound waves.

15. The method of claim 14, further comprising adjusting the input waveform during the exposing step so that the multilayer structure vibrates at the first frequency and the second, different frequency.

16. A system for delaminating a multilayer structure, the system comprising:
a delamination vessel defining an interior chamber configured to contain a liquid medium and a multilayer structure in contact with the liquid medium;
a source mounted to the delamination vessel and configured to generate sound waves that impact the multilayer structure; and
a controller comprising a processor, and a non-transitory computer-readable medium operably coupled to the processor, the non-transitory computer-readable medium comprising instructions that, when executed by the processor perform operations comprising:
exposing a multilayer structure mounted in the delamination vessel and in contact with a liquid medium therein to sound waves characterized by a first frequency and sound waves characterized by a second, different frequency, the multilayer structure comprising a solid front layer, a solid back layer, and a polymer interlayer comprising a polymer in between the solid front layer and the solid back layer, wherein the exposure separates the solid front layer, the solid back layer, the polymer interlayer, or combinations thereof from the multilayer structure.

17. The system of claim 16, wherein the source is configured to generate the sound waves characterized by the first frequency and the system further comprises an additional source configured to generate the sound waves characterized by the second, different frequency.

18. The system of claim 16, wherein the system further comprises a piezoelectric chip configured to provide a response signal corresponding to vibrations of the multilayer structure induced by the sound waves.

19. The system of claim 16, wherein the operations further comprise:
generating frequency domain data according to a frequency sweep protocol;
processing the frequency domain data to determine resonance frequencies of the multilayer structure, the resonance frequencies comprising the first frequency and the second, different frequency and to generate an input waveform for driving a source of the sound waves; and
outputting the input waveform to a waveform generator operably coupled to the source.

20. The system of claim 16, wherein the operations further comprise:
receiving a response signal corresponding to vibrations of the multilayer structure induced by the sound waves; and
adjusting an input waveform outputted to a waveform generator operably coupled to the source so that the multilayer structure vibrates at the first frequency and at the second, different frequency.
